(19) United States
(12) Patent Application Publication
(10) Pub. No.: US 2005/0108261 A1
(43) Pub. Date: May 19, 2005

(54) Geodigital multimedia data processing system and method

(76) Inventors: Joseph Glassy, Missoula, MT (US); David Cubanski, Missoula, MT (US)

Correspondence Address: Shane P. Coleman, Suite 600, 125 Bank Street, Missoula, MT, 59802, US

(21) Appl. No.: 10/980,577

(22) Filed: Nov. 2, 2004

Related U.S. Application Data
(60) Provisional application No. 60/517,453, filed on Nov. 4, 2003.

(51) Int. Cl. G06F 7/00

(52) U.S. Cl. 707/100

(57) ABSTRACT

A method and system are disclosed for processing data by storing a first type of data in a first portion of a data structure in memory and storing a second type of data in a second portion separate from the first type of data. The second portion begins at a predetermined location relative to an end of the data structure. The first type of data may be multimedia data such as image or audio data. The second type of data may relate to a location at which the multimedia data is captured, such as GPS data, orientation data, or range data. An apparatus implements the method by capturing and storing the data according to the method. The apparatus may include a communications port, such as a wireless port, for transmitting the data to a central computer system, for example, from a remote location at which the data is gathered.

### PRIORITY CLAIM

This application claims the benefit of U.S. Provisional Patent Application no. 60/517,453, filed Nov. 4, 2003, which is hereby incorporated by reference.

### FIELD OF INVENTION

The present invention relates to the recording of data using multimedia apparatuses, such as digital cameras and other imaging apparatuses, audio and video recording devices, and word processing applications. More particularly, the present invention relates to the acquisition and processing of data in connection with the multimedia apparatuses.

### BACKGROUND INFORMATION

In various fields it is desirable to collect and record data in locations remote from a central office where the data is ultimately processed or archived, or where decision-makers acting on the data are located. For example, law enforcement officials collect evidence and prepare reports at crime scenes, automobile accidents, etc.; foresters collect data in forests; firefighters collect data related to fires; public works and safety officials collect data on public infrastructure, such as bridges, tunnels, traffic signals, fire hydrants, etc.; military officials collect data related to troop movements and supply management; engineers and architects collect data relating to construction sites; disaster response officials collect data based on natural and other disasters. In these and other examples, individuals travel into the field to collect data and then report that data back to a central computer. It is desirable that the individual collect data completely so that additional trips to the remote location are not required. It is also desirable that the collected data be accurate.

To assist in the collection and recording of data, perhaps the oldest method is to use form documents that require the user to manually write data into fields. More conventional data recording methods allow the user to type the data into a form using a computer. For example, police officers may complete incident reports by entering data into a computer in the vehicle. That data may later be downloaded to a central computer system back at the police station. The word processing file created by the officer is one example of a multimedia file created to collect data. In other examples, data may be collected through still images, video images, or audio files.

It is also desirable to collect various other types of data at the same time as creating the multimedia file(s). For example, a police officer may want to record the date, time, location, etc. of his or her report, whether that report is in the form of a word processing document entered manually by the user, an audio file dictated by the user, a still image captured by the user, or a video image captured by the user. This additional information may be necessary in legal proceedings to authenticate the evidence collected by the police officer. Collectively, these different types of multimedia data (e.g., audio, video, still images, near-infrared images, word processing data, URL links, etc.) and the other data related to the location, time, etc. of the capturing of the multimedia data are all part of the data collected at a single location. One problem with obtaining different types of data is that data related to a single location are not readily associated with each other.

### SUMMARY OF THE INVENTION

There exists a need to provide an improved method and system for processing geodigital multimedia data that overcomes at least some of the above-referenced deficiencies. Accordingly, at least this and other needs have been addressed by exemplary embodiments of a geodigital multimedia data processing method and system according to the present invention. On such embodiment is directed to a method of processing data by storing a first type of data in a first portion of a data structure in memory and storing a second type of data in a second portion of the data structure separate from the first type of data. The second portion of the data structure begins at a predetermined location in the data structure relative to an end of the data structure.

In another exemplary embodiment of the present invention, a method is provided for processing data by acquiring multimedia data for a scene, storing the multimedia data in a data structure, acquiring additional data for the scene when the multimedia data is acquired, and storing the additional data in the data structure. Further, the additional data relates to a location at which the multimedia data is acquired.

In yet another exemplary embodiment of the present invention, an apparatus is provided for retrieving and processing data. The apparatus includes a multimedia data recording apparatus capable of recording multimedia data associated with a location, a sensor capable of recording additional data related to the location, and a processor that causes the multimedia data recording apparatus to record the multimedia data, causes the sensor to record the additional data, and combines the multimedia data and the additional data into a single data structure.

In yet another exemplary embodiment of the present invention, an apparatus is provided for retrieving and processing data related to a location. The apparatus includes means for storing multimedia data in a data structure, means for sensing additional data related to the location when the means for recording records the multimedia data, and means for storing the additional data separate from the multimedia data at a predetermined position in the data structure relative to an end of the data structure.

In yet another exemplary embodiment of the present invention, an apparatus for retrieving data is provided. The apparatus includes means for capturing an image of a scene, means for retrieving additional information of the scene when the image is captured, and means for storing the image data and the additional data in a single data structure. Further, the means for retrieving is connected to the means for capturing. The image data is stored in a first portion of the data structure, and the additional data is stored in a second portion of the data structure separate from the first portion.

In yet another exemplary embodiment of the present invention, a tangible, computer-readable medium is provided having stored thereon computer-executable instructions for performing a method of embedding metadata in a data structure containing multimedia data. The method stores a first type of data in a first portion of a data structure and stores a second type of data in a second portion of the data structure separate from the first portion. Further, the second portion has a predetermined size and includes a unique identifier located at a predetermined position relative to an end of the data structure, and the identifier provides access to the additional data.

In yet another exemplary embodiment of the present invention, a digital imaging apparatus is provided. The apparatus includes a camera adapted to capture a digital image, one or more sensors that retrieve additional data when the camera captures the image, and a processor that executes instructions to combine data for the digital image with the additional data into a single data structure. Further, the additional data comprises location data related to a location of the camera when the image is captured and orientation data related to an orientation of the camera when the image is captured.

In yet another exemplary embodiment of the present invention, a method is provided for processing data recorded at a remote location. Location data is extracted from each of a plurality of data structures. Each data structure relates to a different location and comprises image data in a first portion of the data structure and metadata in a second portion of the data structure. The metadata comprises location data for the image data and is located at a predetermined location relative to the end of the data structure. Each of the data structures is associated with a location on a map, based on the location data.

In yet another exemplary embodiment of the present invention, a tangible computer-readable medium is provided having stored thereon computer-executable instructions for performing a method of processing data recorded at a remote location. The instructions include a first set of instructions that extracts location data from each of a plurality of data structures. Each data structure relates to a different location and comprises image data in a first portion of the data structure and metadata in a second portion of the data structure. The metadata comprises location data for the image data. The metadata is extracted using a unique identifier located at a predetermined location relative to the end of the data structure. A second set of instructions associates each of the data structures with a location on a map, based on the location data.

### BRIEF DESCRIPTION OF DRAWINGS

The detailed description will refer to the following drawings, wherein like numerals refer to like elements, and wherein:

FIG. 1 shows a block diagram of one embodiment of a geodigital multimedia apparatus for capturing and processing data related to a scene;

FIG. 2 shows a flow chart of one embodiment of a method of processing data related to a scene;

FIG. 3 shows an embodiment of a data structure used to store the image data and additional data for a scene;

FIG. 4 is a flow chart of one embodiment of a method performed by a the apparatus for processing the additional data sensed by the sensors;

FIG. 5 shows a block diagram illustrating one embodiment of the combination of data into a RichPoint Object (RPO), or Rich Content Spatial Object (RCSO);

FIG. 6 shows a block diagram illustrating one embodiment of the location state data captured by the sensors to create the Location State Model (LSM) object described with respect to FIG. 5;

FIG. 7 shows a block diagram of an embodiment illustrating interaction between a geodigital multimedia apparatus ; and a central computer system ; used, for example, at a decision-making center;

FIG. 8a shows one embodiment of a screen displayed in connection with data received from a geodigital multimedia apparatus;

FIG. 8b shows another embodiment of another screen that displays graphical representations of data, including the data element shown in FIG. 8a;

FIG. 9a shows another embodiment of a screen that displays data captured by the apparatus; and

FIG. 9b shows another embodiment of a screen showing multiple data items associated with a single record.

### DETAILED DESCRIPTION

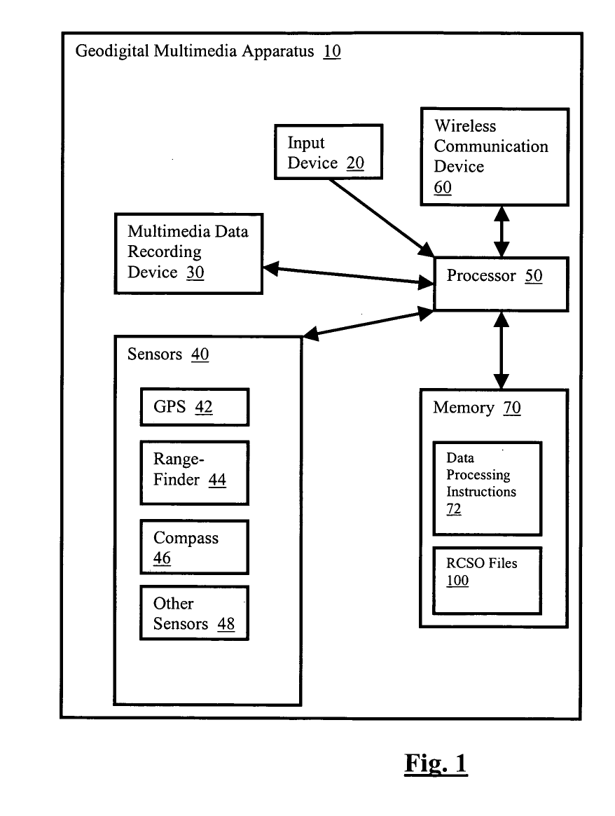

FIG. 1 shows a block diagram of one embodiment of a geodigital multimedia apparatus 10 for capturing and processing data related to a scene. The apparatus 10 includes a multimedia data recording device 30 that gathers data related to one or more types of media, such as still image data, audio data, video data, text, URL information, etc.multimedia data. By way of example, the multimedia data recording device 30 may include one or more of the following: a digital camera, a video camera, an audio recorder, or a text-processing apparatus such as a tablet-PC. The apparatus 10 includes other sensors 40, such as a global positioning system (GPS) sensor 42; a range-finder 44 such as a laser range-finder for determining a distance between the apparatus 10 and a target object; a compass 46, such as a three-axis digital compass; and other sensors 48. In one embodiment, the sensors 40 are physically connected to the apparatus 10. For example, the sensors 40 may be integral to the apparatus 10, contained within or attached to a housing (not shown). In another embodiment, one or more sensors 40 detachably connect to the apparatus 10 and modules allow different types of sensors 40 to interface with the apparatus 10.

The multimedia data recording device 30 and the sensors 40 are connected to a processor 50 that causes the multimedia data recording device 30 and the sensors 40 to collect data. An input device 20 is connected to the processor 50 and causes the processor 50 to capture data using the multimedia data recording device 30 and the sensors 40. Memory 70 stores data processing instructions 72 that perform a method of processing data collected by the multimedia data recording device 30 and the sensors 40. In response to a signal from the user input device 20 (e.g., activation of a shutter control of a digital camera), the apparatus 10 collects multimedia data from the multimedia data recording device 30 and additional data from the sensors 40 and combines both types of data into a single data structure, sometimes referred to as a rich-content spatial object (RSCO) or rich point object (RPO) file 100, which terms are used interchangeably herein. As used herein, multimedia data refers to adapt related to one or more types of media, such as still image data, video data, text, audio data, URL links, etc. As used herein, “metadata” refers to additional data related to the scene of which an image is captured. Metadata, or additional data, includes, for example, location, temperature, humidity, radiation levels, camera orientation, time, distance to a target of the image, data entered manually through a user input device. The file 100 is stored in memory 70. In one embodiment, the additional data from the sensors 40 is encrypted before storing it in the RSCO file 100.

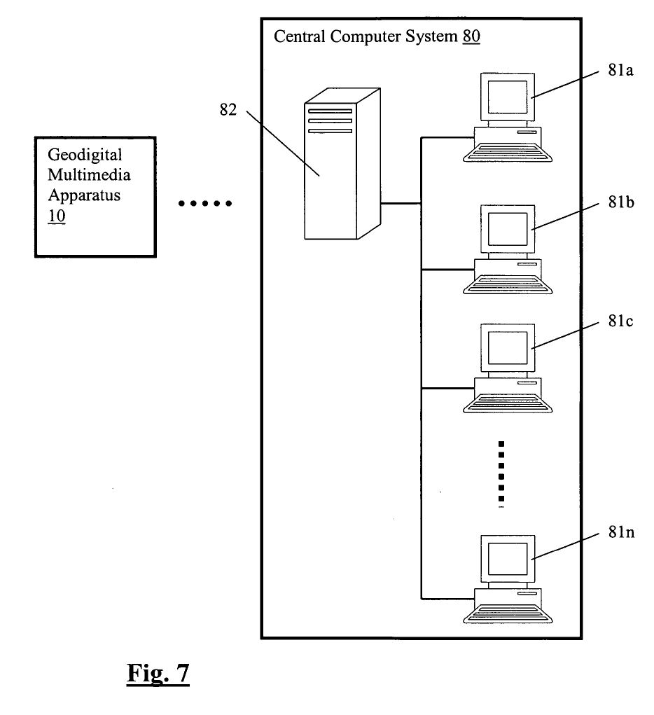

In the example of FIG. 1, the apparatus 10 includes a wireless communications device 60 that allows transmission of the RCSO files 100 to a remote location (see FIG. 7). In one embodiment, these files 100 may be transmitted in real time via a wireless link to a decision-maker located in a remote location. For example, during a fire or a natural disaster, data may be collected at the remote location and then transmitted in real-time to a public official in a remote command center who can make decisions regarding how to act based on the transmitted data. Other embodiments do not include a wireless communications device 60 but instead connect to a central computer system via a docking station (not shown) or other hard-wired connection. In one exemplary embodiment, the wireless protocol used may be 802.11 b/802.11 g/8011 n. In another exemplary embodiment, the wireless protocol used may be Bluetooth (BT). In another exemplary embodiment, the wireless protocol used may be GlobalStar, Irridium, CDMA 1.x, or GSM/GPRS cellular telephone modem may be used.

In the embodiment of FIG. 1, the sensors 40 record the additional data simultaneously with the capturing of the multimedia data by the multimedia data recording device 30. The GPS sensor 42 records the location of the apparatus 10 when the multimedia data is captured (e.g., when a digital image is recorded or when text is entered into a report of a word processing apparatus). The range-finder 44 records a distance between the apparatus 10 and a target object in the scene (such as a building for determining setback distances by a public works inspector). The compass 46 may be a digital compass that records the orientation of the apparatus 10, for example with regard to the azimuth or bearing view angle, and elevation slope angle, corresponding to the observer's facing view at the time the multimedia data is captured. In one embodiment, the compass 46 records pitch, yaw, and roll positions of the apparatus 10 when the multimedia data is captured. The orientation data may be used, for example, where the multimedia data recording device 30 is a digital camera. By capturing multiple images or a target object from different angles and locations, three-dimensional images of the scene can later be created using the orientation, observer-to-subject distance, and GPS data.

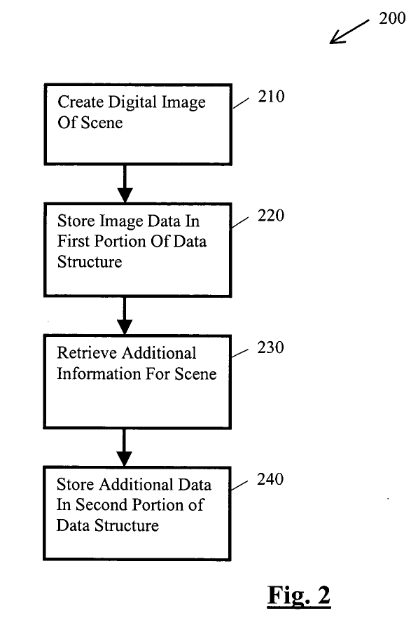

FIG. 2 shows a flow chart of one embodiment of a method 200 of processing data related to a scene. The embodiment shown in FIG. 2 may be implemented on a geodigital multimedia apparatus, such as the apparatus 10 of FIG. 1, in which the multimedia data recording device 30 includes a digital camera for capturing a digital image. Although the method of FIG. 2 is described with respect to digital imaging as the multimedia recording apparatus, one skilled in the art will recognize that other embodiments may retrieve multimedia data other than, or in addition to, digital images. For example, in another embodiment, environmental sensor measurements from an attached sensor such as a portable radioactivity monitor, or temperature, wind-speed, and relative humidity instrument, equipped with an electronic interface, are integrated in real-time by the geodigital-multimedia apparatus described earlier.

A digital image is created 210 for the scene, for example by capturing a still digital image of the scene using a camera or other imaging apparatus, and recording pixel data for the image. Image data for the captured image is stored 220 in a first portion of a data structure stored in memory. Additional data, or “metadata,” related to the scene is retrieved 230, for example, using sensors or other inputs to capture information related to the scene when the image is captured. The additional data is stored 240 in a second portion of the data structure. In one embodiment, the second portion of the data structure begins at a fixed location relative to an end of the data structure (e.g., 512 or 1024 bytes from the end of the data structure). In this embodiment, the additional data may be added to any conventional type of file (e.g., JPEG, TIFF, WAV) without affecting the integrity of the file and without requiring special application software to access the multimedia portion of the data structure 200.

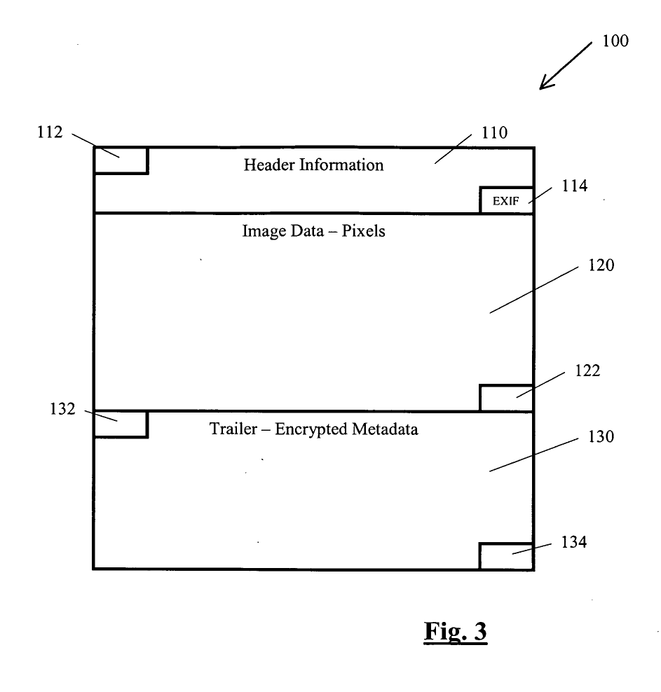

FIG. 3 shows an embodiment of a data structure 100 used to store the image data and additional data for a scene. The embodiment of the data structure 100 of FIG. 3 includes three portions, including a first portion 110 that stores header information related to the data structure 100, a second portion 120 that stores image data, such as pixel data used to display the image, and a third portion 130 that stores additional data, or “metadata.” Image data stored in the second portion 120 may be stored in a conventional format, such as JPEG or TIFF formats. The header information stored in the first portion 110 includes conventional header information typically associated with conventional JPEG, TIFF, or other image files and may be used to identify the data structure 100 as being an image file. The header information includes an identifier 112, sometimes referred to as “cookie” or “magic cookie” as the first byte(s) of the data structure 100 that is used to identify the type of image file. The header information also may include a standard Exchangable Image File Format (EXIF) data collection section, within which a number of sub-sections known as Interoperability Field Data (IFD) information blocks are placed. EXIF information is used to store camera-generated attributes describing picture-taking conditions, such as the lens focal length, exposure settings, and many similar parameters. One of these IFD blocks is dedicated to storing GPS information associated with the image. A marker value in the EXIF identifies the end of the header information in the first portion 110 and the beginning of the image data in the second portion 120. The second portion 120 includes a last byte(s) that indicates the end of the image data. In the embodiment of the data structure 100 shown in FIG. 3, the first and second portions 110, 120 are typical of conventional JPEG and TIFF data structures.

The data structure 100 of FIG. 3 further includes a third “trailer” portion 130, sometimes referred to as a RichPoint Metadata Block (RMB) (sometimes referred to interchangeably as a RichPoint Trailer Block (RTB)), that includes metadata related to the scene for which image data is stored in the second portion 120 of the data structure 100. In one embodiment, the metadata stored in the third portion 130 is encrypted and is invisible to users who do not have the capability of reading metadata from an RCSO file. To these users, the data structure 100 appears as a typical image file—JPEG, TIFF, etc.—with a magic cookie identifier 112, an EXIF block 114, and a final byte(s) 122 of the image file. These users can view the image data stored in the second portion 120 of the data structure 100, but cannot access the metadata in the third portion 130 and may not even know it exists. In this manner, the data structure 100 is backward-compatible insofar as it allows users with conventional image viewers such as common internet web browser software to view the image data of the data structure, if not the metadata.

To a user with compatible software, the metadata stored in the third portion 130 is also available. In one embodiment, the RMB, otherwise known as the RTB, (the third portion 130) has a fixed length (e.g., 512 or 1024 bytes) and an end byte 134 and a start byte 132, or “magic cookie,” that indicates the beginning of the metadata. In this embodiment, software reading a data structure 100 finds the end of the data structure 100 and backs up the fixed length of the RMB 130 to read the start byte 132. Although the RMB 130 is shown as being a trailer block at the end of the data structure 100 in the embodiment of FIG. 3, in other embodiments, other data may be positioned between the RMB 130 and the end of the data structure 100, but the beginning of the RMB 130 is still located a predetermined position (e.g., 512 or 1024 bytes) from the end of the data structure 100. If the viewer is reading a conventional image file, there will be no start byte 132 at the specified point in the data structure 100; whereas, in a data structure 100 such as the one shown in FIG. 3, the start byte 132 will indicate the beginning of the third portion 130 of the data structure 100 and thus the beginning of the metadata.

In one exemplary embodiment of the data structure 100, a fixed-length (e.g., 512 or 1024 byte) data structure is populated with all metadata and for which a one-way hash message digest (using MD-5 by default, or SHA-1 algorithm) is stored. The entire block is encrypted, for example, using an industry standard AES (Rjindael) or Blowfish encryption algorithm using Public Key Cryptography key methods. Other conventional encryption methods or methods hereafter created may be used in other embodiments. In another embodiment, the information of interest which could include the entire media file or just the metadata. These may be processed using encryption and authentication methods just described, or using an original method described here. The information block is encrypted (starting after the magic cookie) using a 4-key (secret key) transformation cipher algorithm that randomly re-orders the bytes using a dynamically calculated reorder sequence driven by one static (hard base) seed key, and a dynamic key that is the product of the three base-1 integers representing the hour {1..23}, minute {1..59}, and second {1..59} respectively, taken from the system time the encryption operation was started. This dynamic key (product) is stored as a 3-byte sequence (the 3 integers each occupy one byte) in the RMB itself. To decrypt the RMB, the user must know (a) the hard base seed key, (b) the location of the 3 dynamic key parameters within the RMB, (c) the proprietary mathematical function the 3 dynamic parameters that were used to create the single dynamic key. This obfuscation method is intended to function as an alternative to the default AES or Blowfish encryption method. Once managed within a robust ANSI SQL database environment such as SyBASE iAnywhere engine, additional data security mechanisms present in the governing (SyBASE ianywhere, or MS SQL Server, or IBM DB2) relational database environment may be used. In application work flows where RCSO information is exported to non-secure formats (e.g. JPEG vl.x images and/or Environmental Systems Research Institute, Inc (ESRI) binary Shapefiles, which do not typically contain embedded security information) the standard embedded RCSO security mechanisms offer a fallback mechanism to provide data security.

The processor 50 assigns a unique integer ID to each active RCSO file 100 instantiated within an interactive session. This dynamically assigned integer identifier, known as a Process ID, is used within the object index mechanism, (as well as in the in-memory, object state tracking mechanism) as an abbreviated de-facto primary key, thus avoiding lengthy compound keys made up of strings and scalar numeric terms.

The object type classifier is used to identify a given RCSO as belonging to a particular type or class of object. Like the RCSO instance ID outlined above, the object type classifier is a system attribute assigned automatically upon instantiation. Initially, we identify RCSO's simply on the basis of the media file format they are associated with e.g. (JPEG, geoTIFF, .MOV, .AVI, .WAV, etc).

In addition to being assigned a unique instance ID, and a non-unique object type, RCSO instances may optionally be associated (within applications) with a default grouping class code. This is typically done on a per-application basis, and allows subsets of active RCSOs that share some common traits, use-context, or attribute to be given a simple grouping code to distinguish them from other RCSO groups. This rudimentary grouping key is provided within the in-memory, binary portion of the information model as a way of accomplishing simple filtering logic closer to the instrument level. It is not meant to to limit the ways that RCSOs may be “grouped” for filtering. Once an RCSO is introduced later in its life cycle to the full relational SQL database where large numbers of complex grouping attribute keys are available, applications are free to use, build upon, or disregard this simple grouping code present in the baseline in-memory model.

The RCSO in total is defined by parameters that attempt to precisely fix the observers collective position in space and time. These may be defined in the context of an observer's “facing view”—the camera's focal plane in the embodiment in which the multimedia data recording device 30 is a camera. A challenge in defining angles such as “pitch, roll, and yaw” with respect to an observer view is that in mobile applications this basic directional orientation may vary considerably. For example, in many traditional cases the observer will direct the camera lens (focal plane) in a near horizontal oblique orientation. In other cases (recording macro scale subject features such as a flower on the ground), the camera lens may face more or less directly downward (nadir view), and so forth. As long as the user understands the way this critical focal plane orientation alters the interpretation of angular scene geometry parameters, the scheme should work effectively. Of course, the RCSO itself must contain a flag indicating this basic context driver. Various other conventions and perspectives may be used for specifying axes of a 3-axis compass and for determining an orientation of the apparatus 10.

In one embodiment, the RCSO includes multiple separate types of metadata in separate portions of the RMB. In one embodiment, an RCSO includes image data in the second portion 120 and metadata in the third portion 130 of the data structure 100, and the metadata includes metadata associated with different security levels. For example, the metadata may include geographical coordinate data that is accessible to all users. This metadata may be stored in a first portion of the RMB 130. The metadata may also include other data, such as radiation data, that is located in a separate portion of the RMB 130 and is accessible only to users having a different security level. In one embodiment, each separate portion of the RMB 130 contains all of the metadata for a particular security level. In the example above, a user with a first security level could access only a first portion of the RMB 130 to obtain the geographical coordinate data, and a user with a second security level could access only a second portion of the RMB 130 having both the geographical coordinate data and the radiation data.

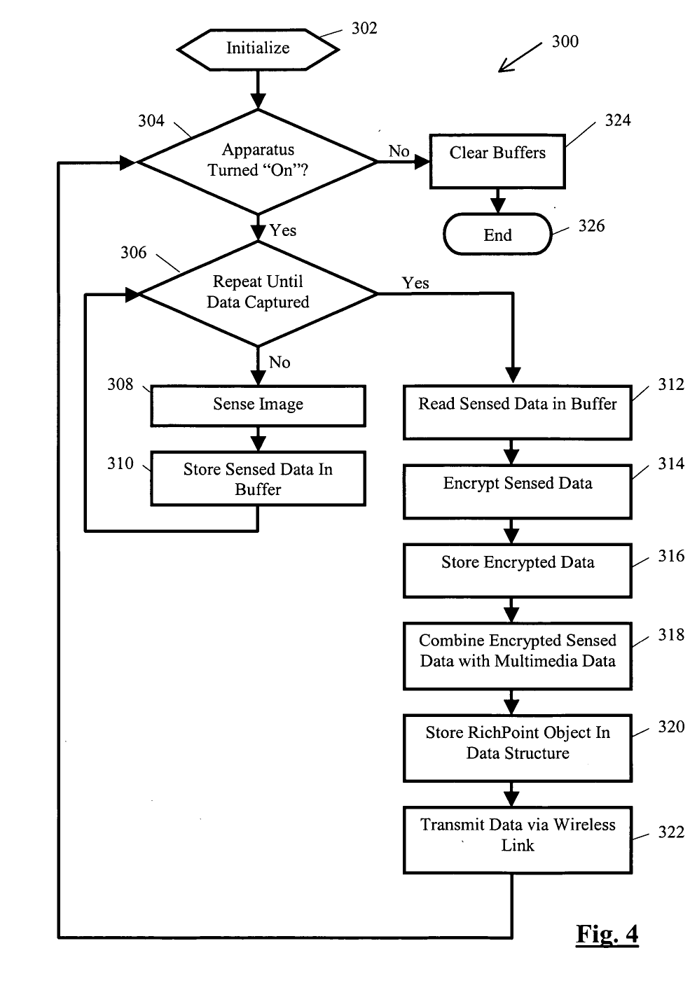

FIG. 4 is a flow chart of one embodiment of a method 300 performed by a the apparatus 10 for processing the additional data sensed by the sensors 40. The method 300 may be embodied, for example, in computer-executable instructions 72 stored in memory 70 of the apparatus 10. The embodiment shown in FIG. 4 may be implemented on a geodigital multimedia apparatus, such as the apparatus 10 of FIG. 1, in which the multimedia data recording device 30 includes a digital camera for capturing a digital image. Although the method of FIG. 4 is described with respect to digital imaging as the multimedia data recording apparatus 30, one skilled in the art will recognize that other embodiments may retrieve multimedia data other than, or in addition to, digital images.

The apparatus 10 begins the method 300 by initializing 302 the sensors 302 to capture data. Data is captured only so long as the apparatus 10 is turned to an “on” mode (“yes” branch of block 304) that allows capturing of data. In the embodiment of FIG. 4, the capturing of data persists until a data capture signal is received (“yes” branch at block 306). A data-capture signal may be a manual input from the input device 20, such as the user operating a shutter control on a camera, or may be an automatic input, such as a periodic (e.g., every 60 seconds, every hour, once per day, etc.) signal that causes the capturing of data automatically. Until a data-capture signal is received (“no” branch at block 306), the sensors 40 of the apparatus 10 are constantly sensing 308 data and storing 310 the sensed data in buffers (not shown), located, for example, in a random access memory (RAM) portion of the memory 70.

Upon receiving a data-capture signal (e.g., a manual signal or a periodically scheduled signal) (“yes” branch at block 306), the processor 50 reads 312 the sensed data that is stored in the buffer. In the embodiment of FIG. 4, the sensed data is then encrypted 314 and the encrypted data is stored 316 in memory 70. Other embodiments do not encrypt the data before storing 316 the sensed data. The encrypted, sensed data is combined 318 with the multimedia data (e.g., pixel data from a still image) and stored 320 in a data structure such as the embodiment of the data structure 100 described with respect to FIG. 3. The data structure 100 is then transmitted 322 to a central location via a wireless link. Other embodiments of the apparatus 10 do not include a wireless communications device 60 but instead download the data structure(s) 100 to a central computer system via a hard-wired connection, such as a Universal Serial Bus (USB) cable, a RS232C serial cable, or a docking station.

The apparatus 10 is designed to capture multiple forms of multimedia and non-location/orientation sensor data, to sense additional location data associated with each of those multimedia data, and to create multiple data structures 100 each containing different multimedia data (e.g., different still images) each having associated with it additional location data sensed by the sensors 40 and appended to the multimedia data in the data structure 10 format. After transmitting 322 a first data object in a first data structure 100, method 300 repeats so long as the apparatus 100 is in an “on” mode (“yes” branch at block 304) and continues to capture and process (blocks 306-322) additional data, with sensed data being associated with particular multimedia data associated therewith. In the embodiment of FIG. 4, data is transmitted 322 one RCSO at a time, after each data file is created from the combined data and stored 320 in a data structure. In other embodiments, the user may obtain multiple RCSO point data instances, and store sets of multimedia data at a remote location and store additional data for each of those sets of multimedia data together in data structures 100, and then transmit multiple RCSOs at once either by a wireless link or by a hard-wired connection. When the apparatus 10 is turned to an “off” mode (“no” branch of block 304), the buffers are cleared 324 and the method 300 ends 306.

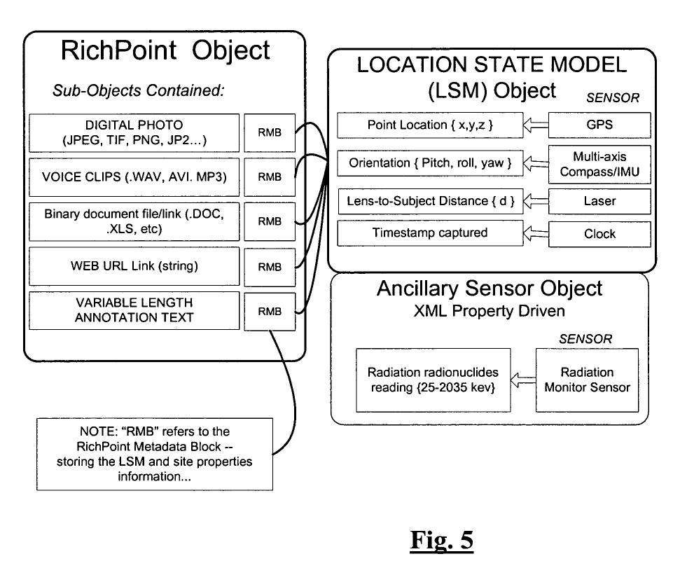

FIG. 5 shows a block diagram illustrating one embodiment of the combination of data into an RCSO. A single RCSO may contain multiple data structures 100, each having associated with multimedia data and additional data attached as an RMB. The embodiment of FIG. 5 illustrates example multimedia data including digital images, audio, binary document files or links (e.g., text data entered by a user into a text input apparatus), a string (such as a network URL link); or a variable-length text annotation. As illustrated generally in the embodiment of FIG. 5, each of these different types of multimedia data is captured at a single point at a single location and is stored in a data structure (100 in FIG. 1) comprising the multimedia data and the additional data received from the sensors (40 in FIG. 1). In the example of FIG. 5, the additional data is data related to the location at which the multimedia data is captured—point location data gathered from a GPS sensor (42 in FIG. 1), orientation data for the apparatus (10 in FIG. 1) gathered from a multi-axis compass (44 in FIG. 1), distance data gathered by a range-finder (46 in FIG. 1), and time data gathered from a clock. In the embodiment of FIG. 5, the location, orientation, distance, and time data are referred to collectively as a “location state model” (LSM) object.

The embodiment of FIG. 5 also contemplates the acquisition of data from additional sensors (48 in FIG. 1), stored in an “ancillary sensor” object. In the embodiment of FIG. 5, the only ancillary sensor is a radiation monitor sensor that reads radiation at the location. This particular sensor may be helpful, for example, in monitoring nuclear power plants and other facilities, where it is desirable to record multimedia data (e.g., an image of a reactor core, an audio file of a dictated report, written text entered into a word processing program, etc.) and to associate that multimedia data with not only LSM object data but also a radiation reading. In one embodiment, this particular sensor may be used in connection with remote-controlled robotic system that captures images periodically or in response to a user's input and also obtains the radiation data, where it may be hazardous for a person to be physically present in the location at which an image is captured.

Together, this location data provides valuable insight into the environment in which the multimedia data was recorded. For an image, for example, it illustrates the precise location from which the image was taken, the orientation of the digital camera when the image was captured, and a distance to a target object in the image. This additional data provides context for the multimedia data and allows easier recreation of the scene as the observed by the apparatus 10 at the time the multimedia data was captured.

In one example, digital still images, associated text blocks, URLs, and audio clips are organized by default as discrete geo-spatial point object subcomponents. A special case is made for digital streaming video due to the nature of the multi-frame sequential information it represents. In one embodiment a given instance of digital streaming video is associated with either a single point (e.g. a tripod pivot point from which a panorama is shot) or may be treated as a vector sequence (e.g. observer is capturing scene imagery while moving).

Rich content spatial objects that are created or maintained within an application typically proceed through a predictable life-cycle sequence. A RCSO life cycle typically starts at the instrument/device level, proceeds to be combined in near real-time with other raw instrument or parameter data, existing at first as an in-memory object (as a class instance, or arrays of class instances, arrays of structures, etc). The life-cycle is considered to “end” as the GDM or GDI information augments or enhances decision support (prior to long term archive as necessary) within a customer business process. Depending on the application, the RCSO is transformed into persistent store (a raw binary file form), typically within application space and often represented within an ANSI SQL database such as the SyBASE iAnywhere). RCSO information then moves through various data communications pathways (e.g. TCP/IP network, or wireless network, or USB, or CF storage card to desktop, etc) then entering the realm of an enterprise information system where data reduction, analysis (and archive) steps are performed, ultimately appearing in reduced form within a decision support context.

In one embodiment, a version tag is provided for all RCSO files 100. This tag clarifies the “generation” a particular group of RCSO objects belong to, and aids in the building and maintaining longer term RCSO databases at the enterprise level. The version tag also supports effective troubleshooting, because it allows for trouble-ticket to match a particular RCSO with the software generation that produced and maintained it.

In one embodiment, a robust cyber-security model is used to address both object and set level security and authentication. In some applications it is desirable that the issuer or recipient of RCSO information may be verified and/or authenticated. For example, a digital image's value may be significantly enhanced if the originator of the photograph may be authenticated to a high degree of certainty, by the recipient. The digital image content itself may not be confidential per se, but its use context (who sent it, who is to receive it, etc) may be extremely confidential, with much of its value hinging on the authenticity of the transaction.

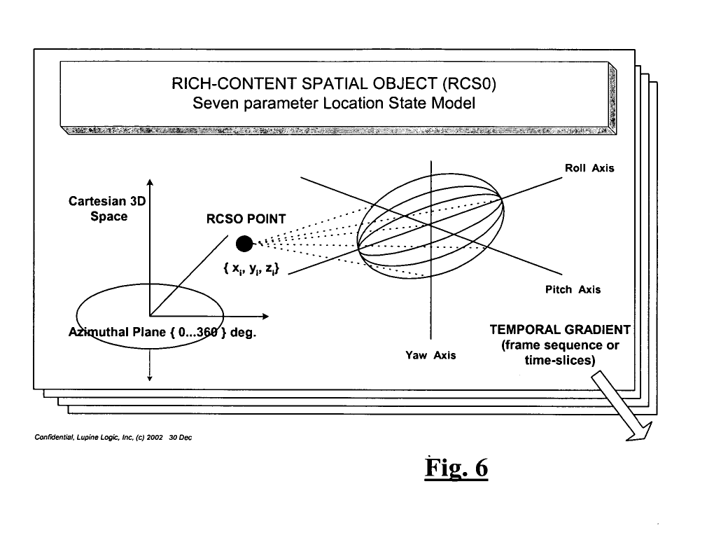

FIG. 6 shows a block diagram illustrating one embodiment of the location state data captured by the sensors 40 to create the LSM object described with respect to FIG. 5. Multimedia data is captured by the apparatus 10 at a particular point at the location, referred to in FIG. 6 as an RCSO point. The RCSO point has a 3-dimensional position (given by the coordinates Xₚ, Yₚ, Zₚ in Cartesian 3-D space) associated with it, which may be obtained using the GPS sensor 42. The apparatus 10 has a particular orientation associated with it when the multimedia data is captured. This orientation may be useful, for example, when the multimedia data is still or video image data. The orientation may be determined by a three-axis compass 44 that provides pitch, roll, and yaw data for the apparatus 10. In another embodiment, the orientation information may be retrieved using a common Inertial Measurement Unit (IMU) or similar platform orientation sensor device. A distance from the apparatus 10 to a target object may be given by a range finder. The distance, location, and orientation data are subject to a temporal gradient in that these values may vary over time, so a time stamp is also associated with this data in the embodiment shown in FIG. 6.

In one embodiment, the observed parameters of interest may be organized from one of two points of view: the observer's viewpoint or a subject viewpoint. The angular orientation parameters in the RCSO are by default recorded with respect to the Observer Point Model—(OPM) an “observer's facing view” or azimuth angle associated with the center of the camera/video lens focal plane. In another embodiment, angular parameters may alternatively be recorded with respect to the Subject Point model—(SPM) the viewpoint of a primary subject prominently within the imaging field of view.

In one embodiment the LSM object data, or any other additional data, is captured at substantially the same time as the multimedia data is captured. For example, with a digital camera, actuation of the camera's shutter control may cause the camera to obtain image data and may also cause the other sensors 40 to gather the additional data at the same time. In an example of a multimedia file containing text input by a user, such as with a report, the additional data may be captured upon initiating or completing entry of the text data.

FIG. 7 shows a block diagram of an embodiment illustrating interaction between a geodigital multimedia apparatus 10 and a central computer system 80 used, for example, at a decision-making center. In the embodiment of FIG. 7, the central computer system 80 includes a server 82 connected to multiple terminals 81a, 81b, 81c, 81n. Users may access the terminals 81a, 81b, 81c, 81n to analyze data recorded by the apparatus 10.

One or more apparatuses 10 may be used to gather data at locations remote from the central computer system 80. The apparatuses 10 provide data to the computer system 80 for analysis. The apparatuses 10 may gather data manually by individuals capturing data at the remote locations or automatically, for example, using apparatuses 10 positioned at the location and configured to periodically capture data or apparatuses sent to a remote site using a remote-controlled transportation means and configured to capture data upon reaching the location automatically or in response to a user's signals from the remote control. In the embodiment shown in FIG. 7, the apparatus 10 transmits collected data to the central computer system 80 via a wireless link, for example, while the apparatus 10 is still positioned at the remote location. In another embodiment, the apparatus 10 connects via a wired connection (e.g., using a serial cable, docking station, etc.) after the apparatus 10 is returned to the physical location of the central computer system 80.

The central computer system 80 can be used to analyze data gathered by the apparatus 10. In one embodiment, the data retrieved by the apparatus 10 is stored in a database located on the server 82, accessible to the terminals 81a, 81b, 81c, 81n. Users of the terminals 81a, 81b, 81c, 81n can analyze the data using software installed on the terminals 81a, 81b, 81c, 81n or server 82 or both. In one embodiment location data is acquired and software displays data associated with particular locations on one or more maps so that the user can view, relative to the map(s), the position(s) at which data was acquired.

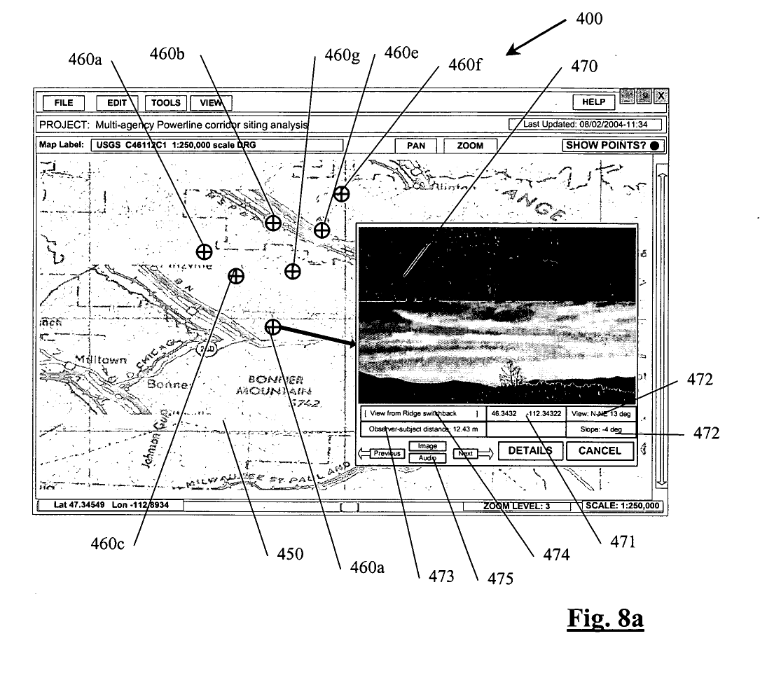

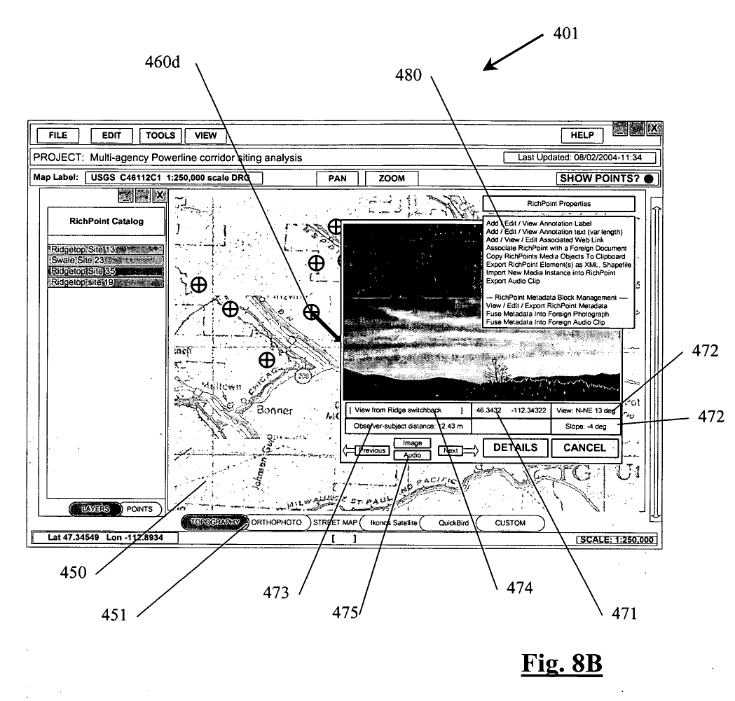

FIG. 8a shows one embodiment of a screen 400 displayed in connection with data received from a geodigital multimedia apparatus 10. The screen 400 can be displayed, for example, on displays of the terminals 81a, 81b, 81c, 81n. In the embodiment of FIG. 8a, the apparatus 10 has captured still image data at each of a plurality of geographical locations 460a-f. Each data structure (e.g., 100 in FIG. 1) includes the image data and the location (e.g., GPS) data for the location. Also in the embodiment of FIG. 8a, the apparatus 10 includes a 3-axis compass and has captured orientation data for the apparatus 10 at the time each image was captured.

Location data points 460a-f are plotted on the map 450 shown on the screen 400. In one embodiment, different map selections are available, for example, allowing the user to zoom in or out relative to a map or to select maps showing different features (e.g., topographical features, street maps, landmarks, etc.). Each of the data points 460a-f shown on the screen 400 is associated with image data and other data. The user in the embodiment of FIG. 8a may access the additional data using a user input device, for example, by using a computer mouse or other pointing device to select one of the data points (e.g., 460d). Image data for the selected data point 460d is displayed on the screen 400 in a separate window, in the embodiment of FIG. 8a. The embodiment of FIG. 8A also displays a location field 471 showing the latitude and longitude at which the image was captured, an orientation field 472 showing the compass angle and slope at which the apparatus 10 was oriented when the image was captured, and a range field 473 showing a distance to a target object in the image. The embodiment of FIG. 8a also allows includes a description field 474 for entry of a title or other textual description of the image. In the embodiment of FIG. 8a, audio, video, or other multimedia data can also be retrieved by the apparatus 10 and can be accessed by selection of a feature displayed on the screen, such as the “audio” icon 475.

FIG. 8b shows another embodiment of another screen 401 that displays graphical representations of data, including the data element 460d shown in FIG. 8a. A menu 480, activated for example by a right-click of a mouse, displays user options for the data. In this embodiment, options are included for adding, editing or viewing an annotation label of the data element; adding, editing, or viewing a variable-length text box; adding, editing, or viewing an associated web link; and other options shown in the menu 480. The embodiment of FIG. 8c also includes icons 451 for the selection of different types maps that may be displayed in connection with the data points (e.g., 460d).

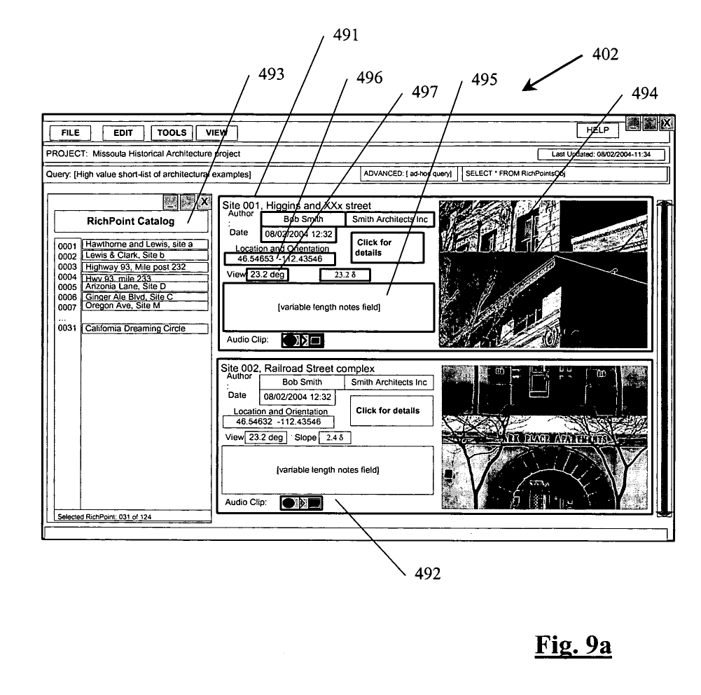

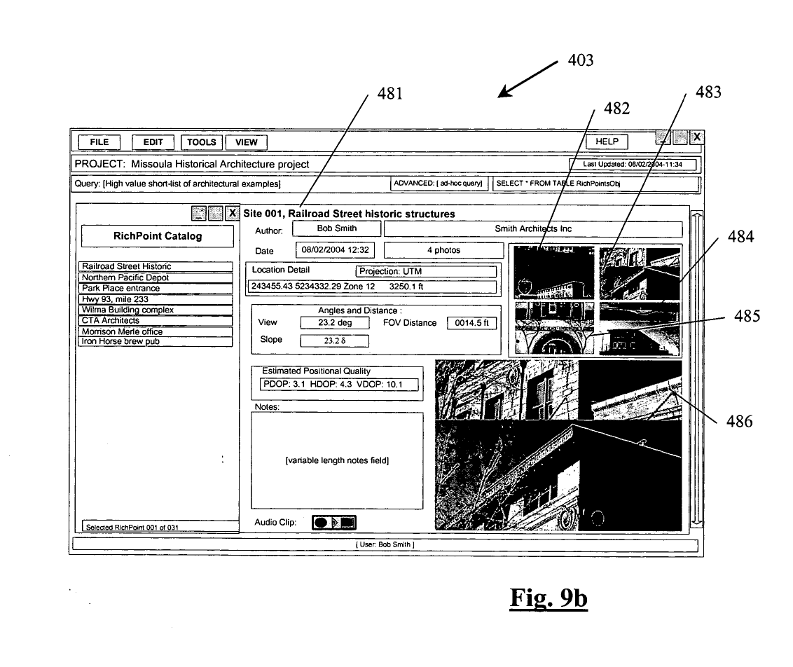

FIG. 9a shows another embodiment of a screen 402 that displays data captured by the apparatus 10. In the embodiment of the screen 402 shown in FIG. 9a, data records 491, 492 are displayed sequentially in a portion of the screen that allows the user to scroll through different records 491, 492. This data display is not shown with respect to a map, such as the map 450 shown in FIGS. 8a and 8b. The records 491, 492 may be accessed by making selections of a catalog 493 displayed on the left portion of the screen 402. Each record includes an image 494, a variable-length text field 495, a location field 496, and an orientation angle 497 in this embodiment.

FIG. 9b shows another embodiment of a screen 403 showing multiple data items 482, 483, 484, 485 associated with a single record 481. In this embodiment, a user may select one of the records 481 and then select one of the data items 486 for display of other data, such as location, range, orientation, notes, date, etc. to be displayed larger than the other items.

Although only selected screens 400, 401, 402, 403 are shown, one skilled in the art will recognize that the present invention may be implemented in software that displays multiple screens of graphical user interfaces (GUIs) and may use various methods of arranging data. For example, data records may be grouped according to different projects or users or time periods.

The present invention may be used in any situation in which it is desirable to record rich-content and metadata for a particular scene stored with associated georeference information as provided by the LSM data model. Example uses include natural resource applications, public works/local and regional government applications, public health and safety and disaster recovery applications, homeland security, forensic science, and engineering.

Example natural resource applications include fire management, forest management, rangeland management and research, recreation management, wildlife management and research, hydrology and wetlands management, national and state parks and monuments management. In the field of fire management, firefighters can use the present invention to capture images and other data associated with a fire and transmit these images and other data (e.g., locations of hot-spots, safety hazards, resource allocation, weather conditions, etc.) in real time to a remote decision-maker. Foresters may use the present invention to capture images and other data relevant to forestry, for example, to analyze soil erosion, pest infestation, fire-damage, and timber harvest methods.

Example public works/local and regional government applications include management and planning of city/county infrastructure and inventory, man caused and natural disaster preparedness planning and disaster recovery, and permit compliance. Example public health and safety applications include disaster preparation, vulnerability analysis, and disaster recovery applications, emergency response and public services, and permit compliance. Example homeland security and forensic science applications include vulnerability assessments and risk analysis, disaster preparedness planning and recovery, forensic science and accident investigations, and emergency first response services. Example engineering applications include highway construction, roadway surface and traffic control maintenance, roadside sign inventory maintenance, and public works condition inventory maintenance.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

1. A method of processing data comprising:
storing a first type of data in a first portion of a data structure in memory; and
storing a second type of data in a second portion of the data structure separate from the first type of data, wherein the second portion of the data structure begins at a predetermined location in the data structure relative to an end of the data structure.

2. The method of claim 1, wherein the second portion of the data structure comprises a unique identifier located at the predetermined location in the data structure, and wherein the unique identifier provides access to the second type of data.

3. The method of claim 1, wherein the second portion of the data structure comprises a unique identifier located at a predetermined location in the data structure relative to an end of the data structure, and wherein the unique identifier provides access to the second type of data.

4. The method of claim 1, wherein the step of storing the second type of data comprises storing the second type of data at a position in the data structure located after the first type of data.

5. The method of claim 4, wherein the step of storing the second type of data comprises storing the second type of data immediately following an end byte associated with the first portion of the data structure.

6. The method of claim 1, wherein the first type of data is the multimedia data related to a scene, and wherein the second type of data is additional data related to a location at which the multimedia data is acquired.

7. The method of claim 6, further comprising acquiring the multimedia data.

8. The method of claim 7, wherein the acquiring the multimedia data comprises capturing an image of the scene.

9. The method of claim 7, wherein the acquiring the multimedia data comprises capturing the digital image using a camera, and further comprising acquiring the additional data using a sensor connected to the camera.

10. The method of claim 9, wherein the acquiring additional data comprises acquiring the additional data when the image is captured.

11. The method of claim 9, wherein the acquiring the second type of data comprises acquiring the second type of data using a sensor integral to the camera.

12. The method of claim 7, wherein the step of acquiring the multimedia data comprises acquiring multimedia data in a form selected from a group of multimedia consisting essentially of still digital images, digital video, audio, and text.

13. The method of claim 6, further comprising acquiring the additional data using a sensor selected from the group of sensors consisting essentially of global positioning systems (GPS), compasses, elevation sensors, orientation sensors, temperature sensors, humidity sensors, radiation sensors, range-finding sensors, elevation sensors, and text input devices.

14. The method of claim 6, wherein the step of storing first type of data comprises storing pixel data for the image.

15. The method of claim 6, wherein the acquiring the additional data comprises acquiring the additional data from a text input connected to the camera.

16. A method of processing data, comprising:
acquiring multimedia data for a scene;
storing the multimedia data in a data structure;
acquiring additional data for the scene when the multimedia data is acquired, wherein the additional data relates to a location at which the multimedia data is acquired; and
storing the additional data in the data structure.

17. The method of claim 16, wherein the step of acquiring the multimedia data comprises capturing an image of the scene.

18. The method of claim 17, wherein the step of acquiring the multimedia data comprises capturing pixel data for a still image of the scene.

19. The method of claim 16, wherein the step of acquiring the additional data comprises using a sensor that detects at least one of (a) a location of point at which the multimedia data is captured and (b) an orientation from which the multimedia data is captured.

20. The method of claim 16, wherein the step of storing comprises storing the additional data in a portion of the data structure separate from the multimedia data, wherein the additional data is stored in a fixed-length data block located a predetermined number of bytes from an end of the data structure.

21. An apparatus for retrieving and processing data comprising:
a multimedia data recording apparatus capable of recording multimedia data associated with a location;
a sensor capable of recording additional data related to the location; and
a processor that causes the multimedia data recording apparatus to record the multimedia data, causes the sensor to record the additional data, and combines the multimedia data and the additional data into a single data structure.

22. The apparatus of claim 21, wherein the processor stores the additional data in a portion of the data structure beginning a predetermined number of bytes from an end of the data structure.

23. The apparatus of claim 22, wherein the processor stores the additional data separate from the multimedia data.

24. The apparatus of claim 21, wherein the sensor is capable of recording additional data related to a location of the apparatus or an orientation of the apparatus, or both, when the multimedia data is recorded.

25. The apparatus of claim 21, wherein the sensor is selected from a group of sensors consisting essentially of a global positioning system (GPS) sensor, a compass, a range-finder, a weather condition sensor, a radiation sensor, and a text input device.

26. The apparatus of claim 21, wherein the multimedia data recording device is selected from the group of devices consisting essentially of still cameras, video cameras, audio recorders, and text input devices.

27. The apparatus of claim 21, further comprising a memory that stores the data structure.

28. The apparatus of claim 21, further comprising a wireless communications device capable of transmitting the data structure to a remote location via a wireless link.

29. An apparatus for retrieving and processing data related to a location, comprising:
means for storing multimedia data in a data structure;
means for sensing additional data related to the location, when the means for recording records the multimedia data; and
means for storing the additional data separate from the multimedia data at a predetermined position in the data structure relative to an end of the data structure.

30. An apparatus for retrieving data comprising:
means for capturing an image of a scene;
means for retrieving additional information of the scene, when the image is captured, wherein the means for retrieving is connected to the means for capturing; and
means for storing the image data and the additional data in a single data structure, wherein the image data is stored in a first portion of the data structure and the additional data is stored in a second portion of the data structure separate from the first portion.

31. The apparatus of claim 30, wherein the means for storing comprises means for storing the additional data in the second portion of the data structure, wherein the second portion of the data structure comprises a unique identifier that provides access to the additional data.

32. The apparatus of claim 31, wherein the unique identifier is located at a predetermined position relative to an end of the data structure.

33. A tangible, computer-readable medium having stored thereon computer-executable instructions for performing a method of embedding metadata in a data structure containing multimedia data, wherein the method comprises:
storing a first type of data in a first portion of a data structure; and
storing a second type of data in a second portion of the data structure separate from the first portion, wherein the second portion has a predetermined size and includes a unique identifier located at a predetermined position relative to an end of the data structure, wherein the identifier provides access to the additional data.

34. The apparatus of claim 33, wherein the first type of data is multimedia data.

35. The apparatus of claim 33, wherein the first type of data is data selected from a group of data types consisting essentially of still image data, video data, audio data, and text data.

36. The apparatus of claim 33, wherein the first type of data is multimedia data related to a scene, and wherein the second type of data is location data related to the scene at the time the first type of data is captured.

37. A digital imaging apparatus comprising:
a camera adapted to capture a digital image;
at least one sensor that retrieves additional data when the camera captures the image, wherein the additional data comprises location data related to a location of the camera when the image is captured and orientation data related to an orientation of the camera when the image is captured; and
a processor that executes instructions to combine data for the digital image with the additional data into a single data structure.

38. The apparatus of claim 33, wherein the camera is a digital still-image camera.

39. The apparatus of claim 33, wherein the camera is a digital video camera adapted to capture a digital video image.

40. The apparatus of claim 33, wherein the processor executes instructions to combine data for the digital image with the additional data into a single data structure, wherein the additional data is located within the data structure at a predetermined location relative to an end of the data file.

41. The apparatus of claim 33, wherein the processor executes instructions to encrypt the additional data before combining the additional data with the image data in the file.

42. The apparatus of claim 33, further comprising memory that stores the data structure.

43. The apparatus of claim 33, further comprising a wireless communications device that transmits the data structure to a remote location.

44. A method of processing data recorded at a remote location, comprising:
extracting location data from each of a plurality of data structures, wherein each data structure relates to a different location and comprises image data in a first portion of the data structure and metadata in a second portion of the data structure, wherein the metadata comprises location data for the image data and wherein the metadata is located at a predetermined location relative to the end of the data structure; and
associating each of the data structures with a location on a map, based on the location data.

45. The method of claim 44, further comprising displaying the map and an icon for each of the data structures on the map, using the location data.

46. The method of claim 45, wherein the location data includes geographic coordinate data at which the image data was obtained and orientation data for a camera orientation at which the image data was obtained.

47. A tangible computer-readable medium having stored thereon computer-executable instructions for performing a method of processing data recorded at a remote location, comprising:
a first set of instructions that extracts location data from each of a plurality of data structures, wherein each data structure relates to a different location and comprises image data in a first portion of the data structure and metadata in a second portion of the data structure, wherein the metadata comprises location data for the image data and wherein the metadata is extracted using a unique identifier located at a predetermined location relative to the end of the data structure; and
a second set of instructions that associates each of the data structures with a location on a map, based on the location data.
